(19) United States
(12) Patent Application Publication
(10) Pub. No.: US 2002/0133474 A1
(43) Pub. Date: Sep. 19, 2002

(54) Method of providing photographic Products and services

(75) Inventors: David E. Fenton, Fairport, NY (US); Wai K. Lam, Webster, NY (US); Steven L. Mizelle, Pittsford, NY (US)

Correspondence Address: Thomas H. Close, Patent Legal Staff, East Kodak Company, 343 State Street, Rochester, NY, 14650-2201, US

(73) Assignee: Eastman Kodak Company

(21) Appl. No.: 09/766,917

(22) Filed: Jan. 22, 2001

(51) Int. Cl. G06F 17/00

(52) U.S. Cl. 705/500

(57) ABSTRACT

A method of providing photographic products and services, includes the steps of: selling a photographic film product to a customer; partially exposing the photographic film product; returning the partially exposed photographic film product to a photofinisher; and providing credit to the customer for the unexposed portion of the photographic film product.

### FIELD OF THE INVENTION

The present invention relates to sales of photographic products and photofinishing services, and more particularly to the sale of photographic film.

### BACKGROUND OF THE INVENTION

In photography, it is often the case that the photographer will have a partially completed roll of film in the camera at the end of a vacation or special event. Oftentimes the photographer will wait until the roll is completely exposed before submitting the roll for photofinishing. This is believed to be due to the frugal nature of the consumer. This behavior often results in a delay of several months, or even years before the roll of film is processed, thereby delaying the viewing of the captured images and reducing the satisfaction of the overall picture taking experience. At the output of photofinishing operations, it is common to see Christmas pictures on the same roll as summer vacation pictures. This delay is believed to be a significant restriction on the overall growth of the photographic market. With the recent development of widely available film scanning and digitization and Internet sharing of images, this delay can be an even greater impediment to the expanded use of these digital image services.

It has long been recognized that chemical-based imaging provides a superior format for creating digital pictures. One severe limitation to use of digitization is the delay involved in completing a roll of film. Images recorded on film may change during extended storage between the time the picture is taken and the time the picture is processed. Harsh storage conditions—high temperature and/or high humidity—can deteriorate the image; radiation damage can also affect high-speed films. It is therefore desirable to process images as soon after they are exposed as is reasonably possible.

There is a need therefore for an improved method for providing photographic products and services that avoids the problems of delay noted above.

### SUMMARY OF THE INVENTION

The need is met according to the present invention by providing a method of providing photographic products and services, that includes the steps of: selling a photographic film product to a customer; partially exposing the photographic film product; returning the partially exposed photographic film product to a photofinisher; and providing credit to the customer for the unexposed portion of the photographic film product.

### ADVANTAGES

The present invention has the advantage that the cost barrier to developing partial rolls is eliminated when credit is given for the unused frames. Without fear of wasting money, the photographer feels free to immediately process any partial rolls of film and obtain the images. Thus a photographer can “file” or utilize pictures in an event-based time frame. With this invention, the photographer need not wait to complete the roll, and can feel free to immediately process and digitize—again without fear of wasting money invested in the whole roll of film.

Many events occur under varying lighting conditions. For example, a wedding may involve indoor and outdoor photography. The desire to match film capability to the conditions can proceed without penalty. Some film format systems, such as APS, are designed to allow mid-roll film changes. With this invention any film can be used in this manner. This invention encourages the photographer to process the film immediately and deliver the best possible images.

### BRIEF DESCRIPTION OF THE DRAWINGS

FIG. 1 is a schematic diagram illustrating the conventional model for providing photographic products and services; and

FIG. 2 is a schematic diagram illustrating a model for providing photographic prints according to the present invention.

### DETAILED DESCRIPTION OF THE INVENTION

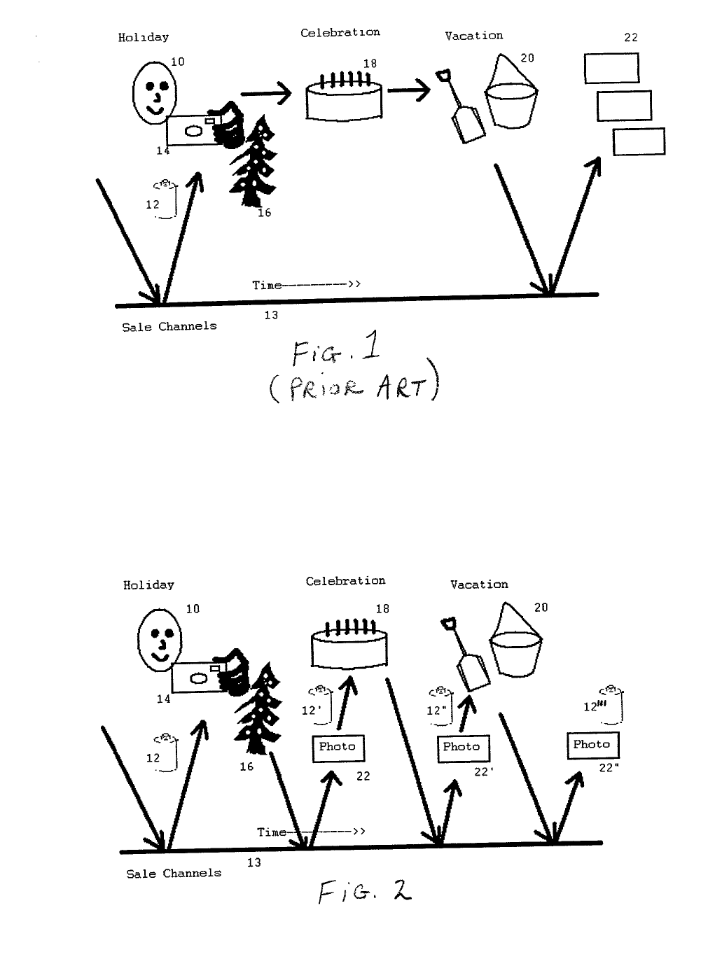

FIG. 1 illustrates the conventional model for providing photographic products and services for amateur photographers. A customer 10 purchases film 12 (or a one time use camera) from a sales channel 13, such as a drug store or photo shop. The film can be for example conventional 35 mm or APS film. The customer 10 uses the film in a camera 14 to capture images of scenes such as a holiday image 16, a birthday image 18, and a vacation image 20 until the entire roll of film is exposed. The customer 10 submits the film 12 for processing, and photographic prints 22 are returned to the customer. This activity may occur over a period of time stretching from hours to months, sometimes even to years.

Referring to FIG. 2, according to one embodiment of the present invention, a customer 10 purchases a roll of film 12 from a sales channel 13 and uses the film to capture one or more images 16 of a single event such as a holiday celebration. After the event, the film 12 is submitted to the sales channel 13 for processing and prints 22 and/or digital image file or image bearing products such as T-shirts, mugs, mouse pads, album pages, etc. are returned to the customer. The customer 10 may purchase a new roll of film 12′ at this time. The film may be purchased at any film sales location, or via the internet. Any unused frames of film from the original roll 12 are counted and credited to the customer 10. The credits can be given and/or taken in various forms such as coupons which could be redeemed for discounts, or free films and processing; reprints; digitization and digital services; picture CDs; digital picture storage; etc. Credits can be awarded to a customer account, for example if the customer is a member of an online image fulfillment service. Credits may also be awarded and tracked using a customer loyalty card that contains a link to a customer database where credits are stored until they are used.

The process can then be repeated for different occasions such as birthdays 18 and vacations 20, each time giving the customer a credit for unused frames on the rolls of film 12′, 12″, 12′″, etc. The process of giving credits for the unused frames of film constitutes the invention that has not been practical and is not practiced at this time. This novel practice provides advantages to the customer as well as to the photo products sales channel since the customer gets more timely access to their pictures and the photo products sales channel does more business.

The process can also be used for special events like a visit to a theme park, a ballgame, concert or auto race. In this scenario, the customer purchases a one-time use camera or a roll of film from a vendor at the event, uses the camera or roll of film at the event, returns the camera or film roll to the vendor when leaving the event and receives credit for unused frames on the roll of film. The credit would arrive with delivery of photographic prints or other photographic products or services, such as digital images, mugs, T-shirts, key chains, etc. The credit can be limited to purchasing event related memorabilia, or event related images taken by a professional photographer.

The invention has been described in detail with particular reference to certain preferred embodiments thereof, but it will be understood that variations and modifications can be effected within the spirit and scope of the invention.

### Parts List

| | |
|---|---|
| 10 | customer |
| 12, 12′, 12′′, 12′′′ | film |
| 13 | sales channel |
| 14 | camera |
| 16 | holiday image |
| 18 | birthday image |
| 20 | vacation image |
| 22 | photographic prints |

What is claimed is:

1. A method of providing photographic products and services, comprising the steps of:
a) selling a photographic film product to a customer;
b) partially exposing the photographic film product;
c) returning the partially exposed photographic film product to a photofinisher; and
d) providing credit to the customer for the unexposed portion of the photographic film product.

2. The method claimed in claim 1, wherein the photographic film product is a roll of photographic film.

3. The method claimed in claim 1, wherein the photographic film product is a one-time use camera.

4. The method claimed in claim 1, wherein the credit is in the form of certificates for photographic products or services.

5. The method claimed in claim 4, wherein the credit for photographic product or services are photofinishing services.

6. The method claimed in claim 4, wherein the credit for photographic product or services are photofinishing services.

7. The method claimed in claim 4, wherein the credit for photographic product or services are credits towards the purchase of film or one-time use cameras.

8. The method claimed in claim 4, wherein the credit for photographic product or services are credits toward the purchase of photographic equipment.

9. The method claimed in claim 4, wherein the credit for photographic product or services are credits toward the purchase of photographic digitization services.

10. The method claimed in claim 9, wherein the photographic digitization services are storage on and access to digital images on the Internet.

11. The method claimed in claim 1, wherein the photographic film product is an APS cartridge.

12. The method claimed in claim 1, wherein the method is used at a special events where the customer purchases the photographic film product from a vendor at the event, uses the photographic film product at the event, and returns the photographic film product to the vendor when leaving the event.

13. The method claimed in a claim 12, wherein the credit arrives with delivery of processed images or other photographic services from the vendor.

14. The method claimed in claim 13, wherein the credit is limited to purchasing event related memorabilia, or event related images taken by a professional photographer.
